(19) United States
(12) Patent Application Publication
(10) Pub. No.: US 2024/0414147 A1
(43) Pub. Date: Dec. 12, 2024

(54) SYSTEMS AND METHODS FOR SECURE SENDING OF LINKED CONTENT WITH AUTOMATED TRACKING

(71) Applicant: JPMORGAN CHASE BANK, N.A., New York, NY (US)

(72) Inventors: Joel POTTS, London (GB); Bret GOLDSMITH, Sugarland, TX (US); Suresh D. RAO, Monroe Township, NJ (US); Josh ABELES, New York, NY (US)

(21) Appl. No.: 18/677,385

(22) Filed: May 29, 2024

Related U.S. Application Data
(60) Provisional application No. 63/506,703, filed on Jun. 7, 2023.

(51) Int. Cl. H04L 9/40

(52) U.S. Cl. CPC H04L 63/0823

(57) ABSTRACT

A method may include: a publishing computer program receiving content from a user electronic device; the publishing computer program saving the content to a secure site; the publishing computer program communicating a first message to a plurality of recipients comprising a link to the content on the secure site; the publishing computer program sending a second message to each of the plurality of recipients with an authentication code; the publishing computer program receiving an access by a recipient electronic device for one of the plurality of recipients; the publishing computer program prompting the one recipient for the authentication code; the publishing computer program presenting the content to the one recipient; a metrics collecting computer program collecting metrics for recipient interaction with the content; and the metrics collecting computer program making the metrics available to the user electronic device.

### RELATED APPLICATIONS

This application claims priority to, and the benefit of, U.S. Provisional Patent Application Ser. No. 63/506,703, filed Jun. 7, 2023, the disclosure of which is hereby incorporated, by reference, in its entirety.

### BACKGROUND OF THE INVENTION

### 1. Field of the Invention

Embodiments relate to systems and methods for secure sending of linked content with automated tracking.

### 2. Description of the Related Art

Organizations often provide advance copies of content, such as presentations, to their clients before meeting. As the clients review the content, software may collect metrics regarding the review, such as how much time is spent on a page, areas that are hovered over, etc. With these metrics, organizations may then better prepare for the meeting, having some insight into the areas of the content that the clients would like to discuss.

### SUMMARY OF THE INVENTION

Systems and methods for secure sending of linked content with automated tracking are disclosed. In one embodiment, a method may include: (1) receiving, by a publishing computer program, content from a user electronic device; (2) saving, by the publishing computer program, the content to a secure site; (3) communicating, by the publishing computer program, a first message to a plurality of recipients, wherein the first message may include a link to the content on the secure site; (4) sending, by the publishing computer program, a second message to each of the plurality of recipients with an authentication code; (5) receiving, by the publishing computer program, an access by a recipient electronic device for one of the plurality of recipients; (6) prompting, by the publishing computer program, the one recipient for the authentication code; (7) presenting, by the publishing computer program, the content to the one recipient; (8) collecting, by a metrics collecting computer program, metrics for recipient interaction with the content; and (9) making available, by the metrics collecting computer program, the metrics to the user electronic device.

In one embodiment, the method may also include: receiving, by the publishing computer program, contact information for the plurality of recipients.

In one embodiment, the method may also include: determining, by the publishing computer program, that there is not a cookie or certificate on the recipient electronic device indicating that the recipient electronic device is registered; validating, by the publishing computer program, an email address for the one recipient and the authentication code; and storing, by the publishing computer program, a cookie or certificate on the recipient electronic device.

In one embodiment, the method may also include: determining, by the publishing computer program, that there is a cookie or certificate on the recipient electronic device indicating that the recipient electronic device is registered; and determining, by the publishing computer program, that the cookie or certificate has not expired.

In one embodiment, the metrics comprise a time spent on a portion of the content, an interaction with a portion of the content, shares of a portion of the content, etc.

In one embodiment, the method may also include: modifying, by the computer program, the content for the one recipient based on prior metrics for the one recipient.

In one embodiment, the method may also include: prompting, by the computer program, a large language model to infer feedback on the content from the metrics and the content; and receiving, by the computer program, inferred feedback from the large language model.

In one embodiment, the method may also include: identifying, by the computer program, information of interest to the one recipient based on the metrics; retrieving, by the computer program, additional information based on the information of interest; and communicating, by the computer program, a third message comprising the additional information.

In one embodiment, the method may also include: maintaining, by the computer program, an audit trail for the content based on the metrics, wherein the metrics identify additional recipients that received or viewed the content via the one recipient.

According to another embodiment, a non-transitory computer readable storage medium, may include instructions stored thereon, which when read and executed by one or more computer processors, cause the one or more computer processors to perform steps comprising: receiving content from a user electronic device; saving the content to a secure site; communicating a first message to a plurality of recipients, wherein the first message may include a link to the content on the secure site; sending a second message to each of the plurality of recipients with an authentication code; receiving an access by a recipient electronic device for one of the plurality of recipients; prompting the one recipient for the authentication code; presenting the content to the one recipient; collecting metrics for recipient interaction with the content; and making available the metrics to the user electronic device.

In one embodiment, the non-transitory computer readable storage may also include instructions stored thereon, which when read and executed by the one or more computer processors, cause the one or more computer processors to perform steps comprising: receiving contact information for the plurality of recipients.

In one embodiment, the non-transitory computer readable storage may also include instructions stored thereon, which when read and executed by the one or more computer processors, cause the one or more computer processors to perform steps comprising: determining that there is not a cookie or certificate on the recipient electronic device indicating that the recipient electronic device is registered; validating an email address for the one recipient and the authentication code; and storing a cookie or certificate on the recipient electronic device.

In one embodiment, the non-transitory computer readable storage may also include instructions stored thereon, which when read and executed by the one or more computer processors, cause the one or more computer processors to perform steps comprising: determining that there is a cookie or certificate on the recipient electronic device indicating that the recipient electronic device is registered; and determining that the cookie or certificate has not expired.

In one embodiment, the metrics comprise a time spent on a portion of the content, an interaction with a portion of the content and/or shares of a portion of the content.

In one embodiment, the non-transitory computer readable storage may also include instructions stored thereon, which when read and executed by the one or more computer processors, cause the one or more computer processors to perform steps comprising: modifying the content for the one recipient based on prior metrics for the one recipient.

In one embodiment, the non-transitory computer readable storage may also include instructions stored thereon, which when read and executed by the one or more computer processors, cause the one or more computer processors to perform steps comprising: prompting a large language model to infer feedback on the content from the metrics and the content; and receiving inferred feedback from the large language model.

In one embodiment, the non-transitory computer readable storage may also include instructions stored thereon, which when read and executed by the one or more computer processors, cause the one or more computer processors to perform steps comprising identifying information of interest to the one recipient based on the metrics; retrieving additional information based on the information of interest; and communicating a third message comprising the additional information.

In one embodiment, the non-transitory computer readable storage may also include instructions stored thereon, which when read and executed by the one or more computer processors, cause the one or more computer processors to perform steps comprising: maintaining an audit trail for the content based on the metrics, wherein the metrics identify additional recipients that received or viewed the content via the one recipient.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for secure sending of linked content with automated tracking according to an embodiment;

FIGS. 2A and 2B illustrate a method for secure sending of linked content with automated tracking according to an embodiment;

FIG. 3 depicts an exemplary computing system for implementing aspects of the present disclosure.

### DETAILED DESCRIPTION OF PREFERRED EMBODIMENTS

Embodiments relate to systems and methods for secure sending of linked content with automated tracking.

Embodiments provide a secure mechanism by which content, such as a presentation, may be made available to one or more recipient, such as clients, and by which metrics may be collected for individuals accessing the content. The metrics may then be provided to the organization.

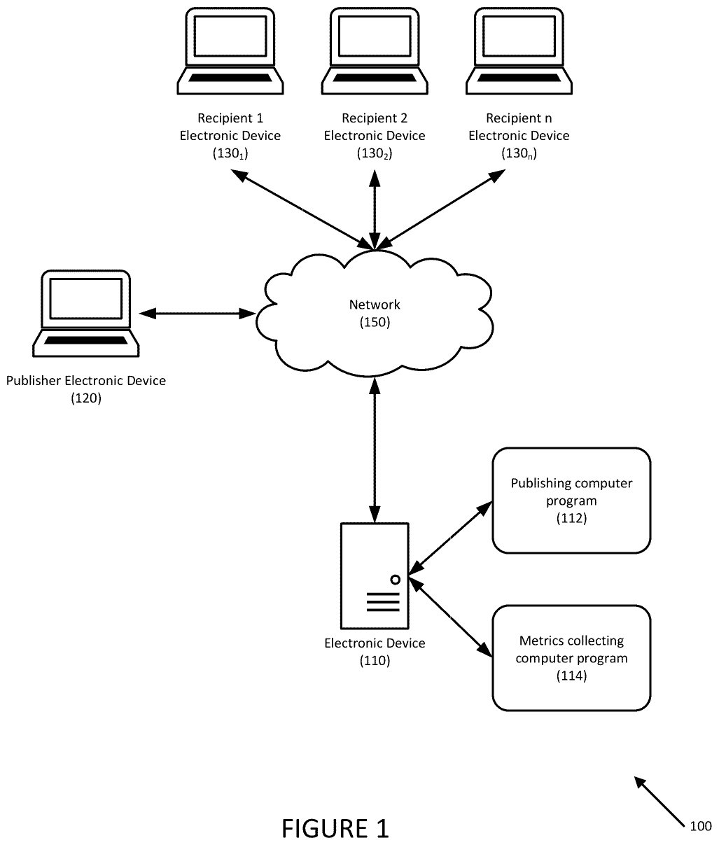

Referring to FIG. 1, a system for secure sending of linked content with automated tracking is disclosed according to an embodiment. System 100 may include electronic device 110, which may be a server (e.g., physical and/or cloud based), a computer (e.g., workstation, desktop, laptop, notebook, tablet, etc.), etc. Electronic device 110 may execute one or more computer programs or applications, including publishing computer program 112 and metric collecting computer program 114.

Publisher electronic device 120 may be used by an organization to provide electronic content, such as a presentation, to publishing computer program 112. Publisher electronic device 120 may be any suitable electronic device, including servers, computers, smart devices, Internet of Things appliances, etc.

In one embodiment, publisher electronic device 120 may execute a computer program (not shown) such as a browser, an email program, etc. that may provide the presentation to publishing computer program 112.

Metrics collecting computer program 114 may monitor access to the presentation by recipients using recipient 1 electronic device 130₁, recipient 2 electronic device 130₂, . . . recipient n electronic device 130ₙ. Recipient electronic devices 130 may access the presentation hosted at a uniform reference locator (URL) provided by publishing computer program.

In one embodiment, electronic device 110, publisher electronic device 120, and recipient electronic device 130 may communicate using network 150, which may be the Internet.

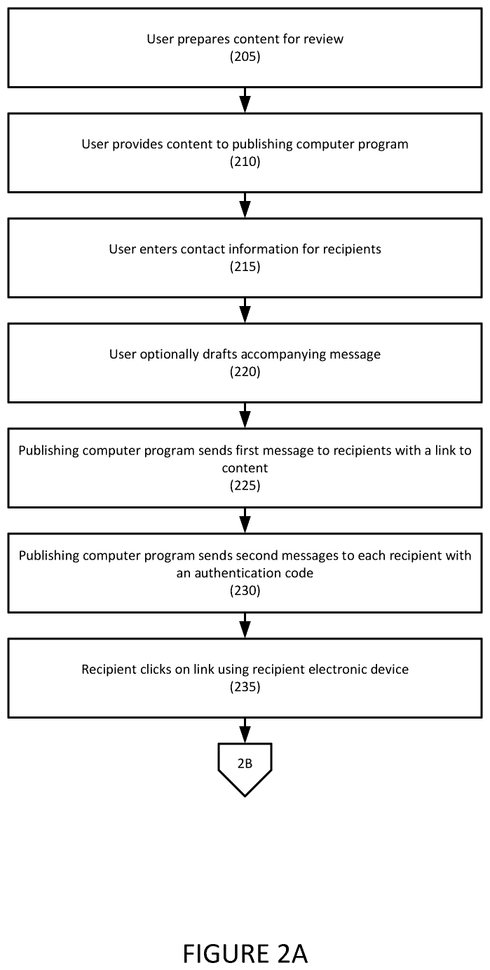

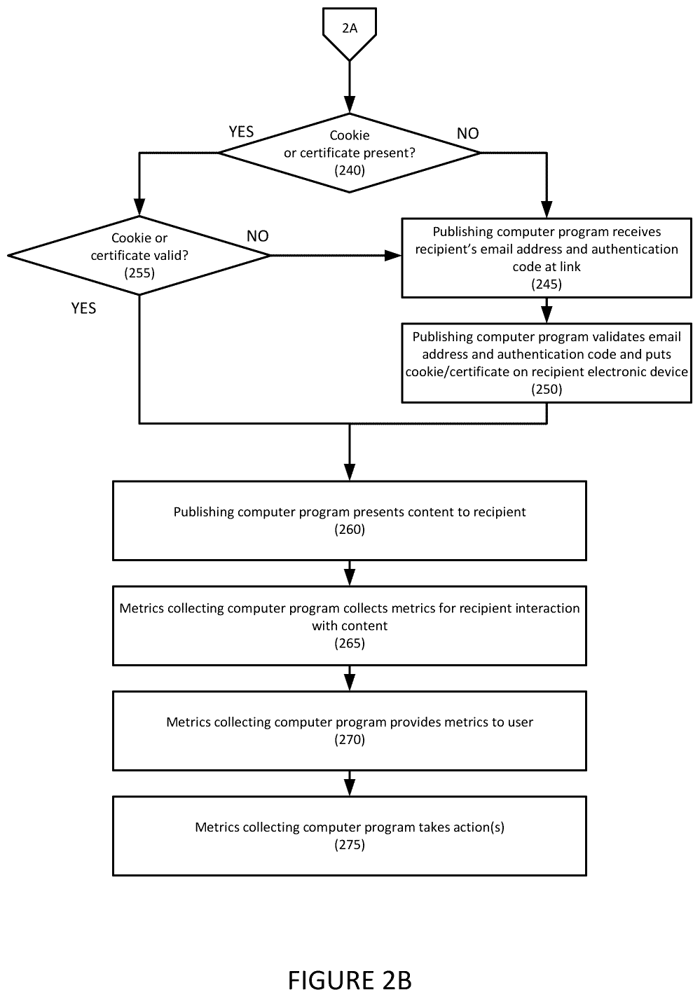

Referring to FIGS. 2A and 2B, a method for secure sending of linked content with automated tracking is provided according to an embodiment.

In step 205, a user may prepare content, such as presentation, for one or more recipients, such as clients. The content may be in any suitable format.

In step 210, the user may provide the content to a computer program, such as a publishing computer program. In one embodiment, the user may upload the content to a website, such as a microsite, for the publishing computer program. In another embodiment, the user may draft an email and attach the content as an attachment. The user may select an integrated tool, such as an add-on, an extension, etc. that may provide the content to the publishing computer program.

In step 215, the user may enter contact information, such as email addresses, for one or more recipient.

In step 220, the user may optionally draft an accompany message for the content.

In step 225, the publishing computer program may receive the content and the contact information for the recipients and may communicate a first message to the recipients. In one embodiment, the publishing computer program may spoof the user's email address so that it appears that the message is coming from the user.

In one embodiment, the publishing computer program may convert the content to a secure document or may secure the site at which the content is hosted.

In one embodiment, the first message may include a link to the content. The link may be a secure link, and the content may only be accessed by the recipients.

In one embodiment, the link may not be unique to each recipient.

In step 230, the publishing computer program may send a second message to each recipient with an authentication code. The authentication code may be a one-time passcode or similar, and the authentication code may be unique to each recipient.

In step 235, each recipient may click on the link using a recipient electronic device.

In step 240, the publishing computer program may determine whether or not there is a cookie or certificate on the recipient electronic device indicating that the recipient electronic device is registered. If there is no cookie present, in step 245, the publishing computer program may prompt the recipient for the recipient's email address and authentication code.

In step 250, the publishing computer program may validate the email address and authentication code. If valid, the publishing computer program may put a cookie/certificate on the recipient electronic device.

If, in step 240, the cookie or certificate is present, in step 255, the publishing computer program may verify that the cookie or certificate is valid (e.g., has not expired). If the cookie or certificate has expired, the publishing computer program may then receive the recipient's email address and authentication code at step 245.

If the cookie or certificate is valid or has been written to the recipient's electronic device, in step 260, the publishing computer program may present the content to the recipient.

In step 265, a metrics collecting computer program may collect metrics for any recipient interaction with the content. In one embodiment, because the recipient's authentication code or cookie/certificate is known, the recipient's interactions with the content (e.g., time spent on a portion of the content (e.g., a slide), clicks or other interactions with content, hovers over content, emailing the content, sharing the content via a screen share, a number of accesses, etc. may be associated with a specific recipient. Other metrics, such as the date and time(s) of access, the type of recipient device, the length of access, etc. may be collected as is necessary and/or desired.

In step 270, the metric collecting computer program may make the metrics available to the user, along with any insights (e.g., areas of the content that the recipients the most time on, areas that recipients spent the least amount of time on, etc.) that can be gleaned from the metrics. The metrics may be aggregated, or they may be provided for each recipient.

In one embodiment, the metrics may be used, in conjunction with a trained machine learning engine, a large language model, etc. to discern the recipient's intent, such as a business intent. For example, the metrics may be provided with the content to a large language model with a prompt to determine the recipient's intent from the metrics.

Similarly, the trained machine learning model or large language model may be used to infer recipient feedback on the content, the value of the content to the recipient, etc. from the metrics.

In another embodiment, the metrics collecting computer program may maintain an audit trail based on the recipient, as well as other individuals that had access to the content (e.g., the recipient shared the content, shared a screen while viewing the content, etc.). In embodiments, automated reports may be generated incorporating the information from the audit trail.

In step 275, the metric collecting computer program, or another computer program, may take one or more actions based on the metrics. For example, if the metrics indicate that a recipient spends more time on a specific portion of a document than others, the metric collecting computer program may update a template that is used for presentations with the recipient to reflect the time spent.

As another example, the publishing computer program may reformat or update a content to reflect this time spent the next time that content is sent to the recipient. Thus, even though the user may provide one content to the publishing computer program, the publishing computer program may personalize the content for each recipient so that the recipient receives content formatted in the most useful way for the recipient.

In another embodiment, if the metrics indicate that a recipient is spending a certain amount of time on a certain portion of the content, highlighting or hovering over certain words, images, etc., the publishing computer program may communicate additional details (e.g., links to the additional content) that may be related to that portion of content.

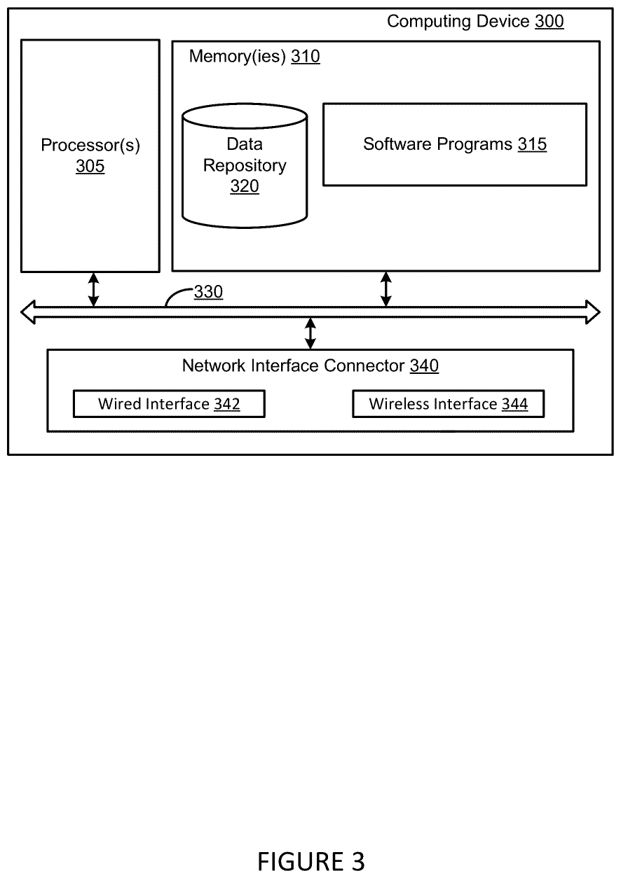

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a publishing computer program, content from a user electronic device;
saving, by the publishing computer program, the content to a secure site;
communicating, by the publishing computer program, a first message to a plurality of recipients, wherein the first message comprises a link to the content on the secure site;
sending, by the publishing computer program, a second message to each of the plurality of recipients with an authentication code;
receiving, by the publishing computer program, an access by a recipient electronic device for one of the plurality of recipients;
prompting, by the publishing computer program, the one recipient for the authentication code;
presenting, by the publishing computer program, the content to the one recipient;
collecting, by a metrics collecting computer program, metrics for recipient interaction with the content; and
making available, by the metrics collecting computer program, the metrics to the user electronic device.

2. The method of claim 1, further comprising:
receiving, by the publishing computer program, contact information for the plurality of recipients.

3. The method of claim 1, further comprising:
determining, by the publishing computer program, that there is not a cookie or certificate on the recipient electronic device indicating that the recipient electronic device is registered;
validating, by the publishing computer program, an email address for the one recipient and the authentication code; and
storing, by the publishing computer program, a cookie or certificate on the recipient electronic device.

4. The method of claim 1, further comprising:
determining, by the publishing computer program, that there is a cookie or certificate on the recipient electronic device indicating that the recipient electronic device is registered; and
determining, by the publishing computer program, that the cookie or certificate has not expired.

5. The method of claim 1, wherein the metrics comprise a time spent on a portion of the content.

6. The method of claim 1, wherein the metrics comprise an interaction with a portion of the content.

7. The method of claim 1, wherein the metrics comprise shares of a portion of the content.

8. The method of claim 1, further comprising:
modifying, by the computer program, the content for the one recipient based on prior metrics for the one recipient.

9. The method of claim 1, further comprising:
prompting, by the computer program, a large language model to infer feedback on the content from the metrics and the content; and
receiving, by the computer program, inferred feedback from the large language model.

10. The method of claim 1, further comprising:
identifying, by the computer program, information of interest to the one recipient based on the metrics;
retrieving, by the computer program, additional information based on the information of interest; and
communicating, by the computer program, a third message comprising the additional information.

11. The method of claim 1, further comprising:
maintaining, by the computer program, an audit trail for the content based on the metrics, wherein the metrics identify additional recipients that received or viewed the content via the one recipient.

12. A non-transitory computer readable storage medium, including instructions stored thereon, which when read and executed by one or more computer processors, cause the one or more computer processors to perform steps comprising:
receiving content from a user electronic device;
saving the content to a secure site;
communicating a first message to a plurality of recipients, wherein the first message comprises a link to the content on the secure site;
sending a second message to each of the plurality of recipients with an authentication code;
receiving an access by a recipient electronic device for one of the plurality of recipients;
prompting the one recipient for the authentication code;
presenting the content to the one recipient;
collecting metrics for recipient interaction with the content; and
making available the metrics to the user electronic device.

13. The non-transitory computer readable storage medium of claim 12, further including instructions stored thereon, which when read and executed by the one or more computer processors, cause the one or more computer processors to perform steps comprising:
receiving contact information for the plurality of recipients.

14. The non-transitory computer readable storage medium of claim 12, further including instructions stored thereon, which when read and executed by the one or more computer processors, cause the one or more computer processors to perform steps comprising:
determining that there is not a cookie or certificate on the recipient electronic device indicating that the recipient electronic device is registered;
validating an email address for the one recipient and the authentication code; and
storing a cookie or certificate on the recipient electronic device.

15. The non-transitory computer readable storage medium of claim 12, further including instructions stored thereon, which when read and executed by the one or more computer processors, cause the one or more computer processors to perform steps comprising:
determining that there is a cookie or certificate on the recipient electronic device indicating that the recipient electronic device is registered; and
determining that the cookie or certificate has not expired.

16. The non-transitory computer readable storage medium of claim 12, wherein the metrics comprise a time spent on a portion of the content, an interaction with a portion of the content and/or shares of a portion of the content.

17. The non-transitory computer readable storage medium of claim 12, further including instructions stored thereon, which when read and executed by the one or more computer processors, cause the one or more computer processors to perform steps comprising:
modifying the content for the one recipient based on prior metrics for the one recipient.

18. The non-transitory computer readable storage medium of claim 12, further including instructions stored thereon, which when read and executed by the one or more computer processors, cause the one or more computer processors to perform steps comprising:
prompting a large language model to infer feedback on the content from the metrics and the content; and
receiving inferred feedback from the large language model.

19. The non-transitory computer readable storage medium of claim 12, further including instructions stored thereon, which when read and executed by the one or more computer processors, cause the one or more computer processors to perform steps comprising:
identifying information of interest to the one recipient based on the metrics;
retrieving additional information based on the information of interest; and
communicating a third message comprising the additional information.

20. The non-transitory computer readable storage medium of claim 12, further including instructions stored thereon, which when read and executed by the one or more computer processors, cause the one or more computer processors to perform steps comprising:
maintaining an audit trail for the content based on the metrics, wherein the metrics identify additional recipients that received or viewed the content via the one recipient.
